(19) United States
(12) Patent Application Publication
(10) Pub. No.: US 2019/0352135 A1
(43) Pub. Date: Nov. 21, 2019

(54) ELEVATOR SYSTEM AND METHOD OF CONTROLLING A DOOR IN AN ELEVATOR SYSTEM

(71) Applicant: Otis Elevator Company, Farmington, CT (US)

(72) Inventors: Peter Herkel, Berlin (DE); Ruediger Loeb, Hennigsdorf (DE)

(21) Appl. No.: 16/415,704

(22) Filed: May 17, 2019

(30) Foreign Application Priority Data
May 18, 2018 (EP) 18173248.8

(51) Int. Cl. B66B 13/14; B66B 9/00; B66B 13/06

(52) U.S. Cl. CPC B66B 13/146; B66B 13/143; B66B 13/06; B66B 9/00

(57) ABSTRACT

An elevator system (2) comprises at least one elevator car (6) moving within a hoistway (4); at least one door (10, 11) providing access to the elevator car (6); at least one passenger sensor (21) configured for detecting passengers (30) in the vicinity of the at least one door (10, 11); and a door control device (22) configured for controlling the at least one door (10, 11). The door control device (22) comprises a memory (24) in which at least one predefined movement profile is stored; a modificator (28) configured for modifying the at least one predefined movement profile when the at least one passenger sensor (21) detects a passenger (30) in the vicinity of the at least one door (10, 11); and a door controller (26) configured for controlling the movement of the at least one door (10, 11) based on the at least one movement profile.

### FOREIGN PRIORITY

This application claims priority to European Patent Application No. 18173248.8, filed May 18, 2018, and all the benefits accruing therefrom under 35 U.S.C. § 119, the contents of which in its entirety are herein incorporated by reference.

### BACKGROUND

The invention relates to an elevator system. The invention in particular relates to controlling the movement of the doors of an elevator system.

An elevator system comprises at least one elevator car traveling along a hoistway between a plurality of landings. Doors provided at the landings and at the elevator car allow passengers to transfer between the landings and the elevator car. The elevator system may further comprise passenger sensors configured for detecting the presence of passengers in the vicinity of the doors. Such passenger sensors allow preventing a door from closing while a passenger is passing the door.

In case the range of detection of the passenger sensors is set to a small range close to the door, the presence of a passenger approaching the door is not detected until the passenger reaches the door. In consequence, the door may be closed just in front of the passenger. On the other hand, if the range of detection is widened to a larger range extending into some distance from the door, there is some risk that the doors do not close for a long period of time, e.g. due to persons passing by the door without entering the elevator car. As a result, the efficiency of the elevator system is deteriorated.

It therefore is desirable to improve the control of the doors in order to improve the comfort for the passengers without considerably deteriorating the running efficiency of the elevator system.

### SUMMARY

According to an exemplary embodiment of the invention, an elevator system comprises at least one elevator car moving within a hoistway; at least one door providing access to the elevator car; at least one passenger sensor configured for detecting passengers in the vicinity of the at least one door; and a door control device configured for controlling the at least one door. The door control device comprises: a memory in which at least one predefined movement profile is stored; a modificator configured for modifying the at least one predefined movement profile when the at least one passenger sensor detects the presence of a passenger in the vicinity of the at least one door; and a door controller configured for controlling the movement of the at least one door based on the at least one movement profile which has been modified or not.

Exemplary embodiments of the invention also include a method of controlling the movement of at least one door of an elevator system, the at least one door providing access to an elevator car of the elevator system. The method includes retrieving a predefined movement profile for the at least one door from a memory; detecting the presence of at least one passenger in the vicinity of the at least one door; modifying the predefined movement profile when the presence of at least one passenger in the vicinity of the at least one door has been detected; and controlling the movement of the at least one door according to the retrieved movement profile which has been modified or not.

Predefined movement profiles allow flexibly controlling at least one door of an elevator system according to the respective operating conditions in particular including the presence or absence of passengers in the vicinity of the elevator system. The predefined movement profiles may include different movement profiles associated with different operational conditions of the elevator system. The predefined movement profiles in particular may include a predefined movement profile for closing the at least one door, a predefined movement profile which causes the movement of the at least one door to stop before the at least one door is completely closed, and a predefined movement profile which causes the at least one door to start closing but then to reverse and (re)open. The predefined movement profiles including stopping and/or reversing the movement of the at least one door in particular may be used when the presence of a passenger in the vicinity of the at least one door has been detected.

Selecting one of a plurality of predefined movement profiles is not considered as modifying a predefined movement profile according to the present invention. Instead, according to the present invention, a predefined movement profile, which has been selected before or will be selected later, is modified resulting in a new, modified movement profile, which is not predefined.

Modifying predefined movement profiles stored in a memory adds additional flexibility to the door movement. It allows adjusting the door movement even finer to the actual needs enhancing the comfort and user experience of the passengers without considerably deteriorating the running efficiency of the elevator system.

A number of optional features are set out in the following. These features may be realized in particular embodiments, alone or in combination with any of the other features.

The at least one door may be one of the landing doors of the elevator system. The at least one door also may be the door of the elevator car (car door). The car door and the landing door provided at the landing, at which the elevator car is positioned when the doors are opened, may be moved concurrently using the same movement profile.

The door control device may comprise a selector configured for selecting one of the at least one predefined movement profiles stored within the memory. The selection may be based on the current operational conditions of the elevator system.

Modifying a predefined movement profile may include modifying a predefined movement profile so that it results in stopping the movement of the at least one door or reversing the moving direction of the at least one door for (re)opening the at least one door. Stopping the movement of the at least one door and/or reversing the moving direction of the at least one door allows a passenger arriving late at the at least one door to enter the elevator car even if the at least one door is already closing.

Modifying a predefined movement profile may include modifying a predefined movement profile so that it results in reducing the movement velocity of the at least one door. Reducing the movement velocity of the at least one door gives a passenger approaching the elevator system more time for reaching and entering the elevator car. Contrary to stopping or reversing the movement of the at least one door, reducing the movement velocity of the at least one door does not block further operation of the elevator system. This is beneficial in particular in situations in which a person approaching the elevator system does not intend to enter the elevator car.

Modifying a predefined movement profile may include multiplying a moving velocity of the elevator car given by a predefined movement profile with a numerical adjustment factor. A negative adjustment factor results in a reversal of the moving direction of the at least one door. If the absolute value of the adjustment factor is below 1, the modification results in reducing the moving velocity of the at least one door. If the absolute value of the adjustment factor is larger than 1, the modification results in increasing the moving velocity of the at least one door. If the adjustment factor is zero, the movement of the at least one door is stopped.

The adjustment factor may be a constant factor. Alternatively, the adjustment factor may be variable over time and/or it may depend on the position of the at least one door along its path. A flexible adjustment factor adds even more flexibility to the modification of the door movement allowing for an even finer tuning of the movement of the at least one door.

The at least one passenger sensor may be configured for detecting the distance of at least one passenger from the at least one door. The at least one passenger sensor in particular may be configured for detecting the distance of the passenger located closest to the at least one door. In such a configuration, the modification of the movement profile may depend on the detected distance of the at least one passenger from the at least one door.

The at least one passenger sensor may be configured for detecting a moving speed of at least one passenger in the vicinity of the at least one door. The at least one passenger sensor in particular may be configured for detecting the moving speed of the passenger located closest to the at least one door. In such a configuration, the modification of the movement profile may be varied according to the detected moving speed of the at least one passenger.

Detecting the distance and/or the moving speed of at least one passenger in the vicinity of the at least one door allows adjusting the movement of the at least one door more specifically to said at least one passenger. It in particular allows preventing that the at least one door is closed just in front of a passenger approaching the door for entering into the elevator car. As a result, the user experience of the passengers is further enhanced.

The selector, the door controller and the modificator may be implemented in hardware as an electronic circuit, respectively. The selector, the door controller and the modificator in particular may include an application-specific integrated circuit (ASIC) customized for the respective tasks. Additionally or alternatively, the selector, the door controller and the modificator may include a programmable (micro-)processor, which is controlled by an appropriate program for executing the desired tasks.

At least two of the selector, the door controller and the modificator may be integrated into a single unit, or they may be provided as separate units of the door control device.

### DRAWING DESCRIPTION

In the following an exemplary embodiment of the invention is described with reference to the enclosed figures.

FIG. 1 schematically depicts an elevator system comprising an elevator car according to an exemplary embodiment of the invention.

FIG. 2 depicts a schematic view of a door control device according to an exemplary embodiment.

FIGS. 3A to 3C schematically illustrate a plurality of exemplary movement profiles.

### DETAILED DESCRIPTION

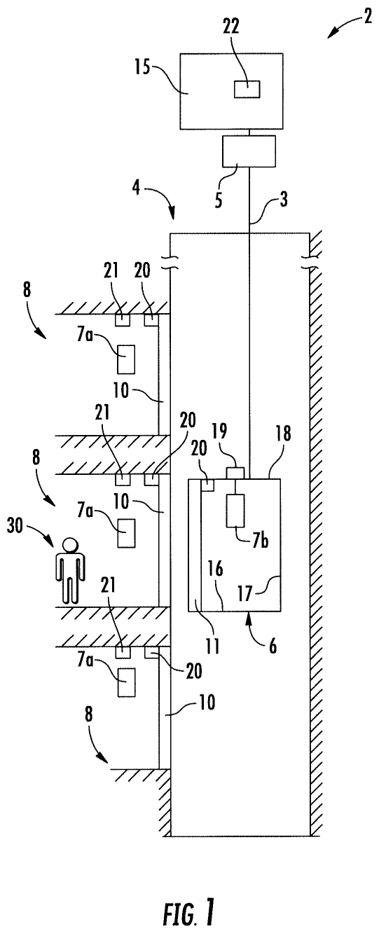

FIG. 1 schematically depicts an elevator system 2 comprising an elevator car 6 according to an exemplary embodiment of the invention.

The elevator system 2 comprises a hoistway 4 extending in a vertical direction between a plurality of landings 8 located on different floors.

The elevator car 6 comprises a floor 16, a ceiling 18 and sidewalls 17 extending between the floor 16 and the ceiling 18 defining an interior space of the elevator car 6. Only one sidewall 17 is depicted in the schematic illustration of FIG. 1.

The elevator car 6 is movably suspended within the hoistway 4 by means of a tension member 3. The tension member 3, for example a rope or belt, is connected to a drive 5, which is configured for driving the tension member 3 in order to move the elevator car 6 along the longitudinal direction/height of the hoistway 4 between the plurality of landings 8.

Each landing 8 is provided with a landing door (elevator hoistway door) 10, and the elevator car 6 is provided with a corresponding elevator car door 11 allowing passengers 30 to transfer between a landing 8 and the interior space of the elevator car 6 when the elevator car 6 is positioned at the respective landing 8.

The exemplary embodiment of the elevator system 2 shown in FIG. 1 employs a 1:1 roping for suspending the elevator car 6. The skilled person, however, easily understands that the type of the roping is not essential for the invention and that different kinds of roping, e.g. a 2:1 roping, may be used as well. The elevator system 2 may further include a counterweight (not shown) moving concurrently and in opposite direction with respect to the elevator car 6. Alternatively, the elevator system 2 may be an elevator system 2 without a counterweight, as it is shown in FIG. 1. The elevator system 2 may have a machine room or may be a machine room-less elevator system. The elevator system 2 may use a tension member 3, as it is shown in FIG. 1, or it may be an elevator system without a tension member 3, comprising e.g. a hydraulic drive, or a linear drive (not shown).

The drive 5 is controlled by an elevator control 15 for moving the elevator car 6 along the hoistway 4 between the different landings 8.

Input to the elevator control 15 may be provided via elevator hall call buttons 7a, which are provided on each landing 8 close to the elevator landing doors 10, and/or via elevator car control buttons 7b provided inside the elevator car 6.

The elevator hall call buttons 7a may include destination call buttons allowing passengers to enter their respective destinations before entering the elevator car 6. When the elevator hall call buttons 7a are provided as destination call buttons, no elevator car control buttons 7b need to be provided inside the elevator car 6.

The elevator hall call buttons 7a and the elevator car control buttons 7b may be connected to the elevator control 15 by means of electrical lines, which are not shown in FIG. 1, in particular by an electric bus, e.g. a field bus such as a CAN bus, or by means of wireless data transmission.

In order to determine the current position of the elevator car 6, the elevator car 6 is provided with a position sensor 19. This, however, is only an example and the skilled person will understand that any suitable methods and/or devices for determining the position of the elevator car 6 within the hoistway 4 may be employed.

At least one passenger sensor 21 configured for detecting the presence of passengers 30 is provided at each landing 8 in the vicinity of the respective landing door 10.

The at least one passenger sensor 21 in particular may be an optical sensor including an IR-sensor which is configured for detecting the heat emitted by a human body.

The at least one passenger sensor 21 may be configured for detecting the number of passengers 30 being present in a predetermined range in the vicinity of the respective landing door 10.

Alternatively or additionally, the at least one passenger sensor 21 may be configured for detecting the distance of at least one passenger 30 from the respective landing door 10 and/or the moving speed of the at least one passenger 30 towards the landing door 10. The at least one passenger sensor 21 in particular may be configured for detecting the distance and/or moving speed of the passenger 30 closest to the respective landing door 10 towards the landing door 10.

The elevator system 20 further comprises at least one door control device 22 configured for controlling the movement of the landing doors 10 and the elevator car door 11.

The at least one door control device 22 may be a central door control device 22 configured for controlling the movement of the elevator car door 11 and all landing doors 11 of the elevator system 2. The at least one door control device 22 may be integrated with the elevator control 15 as shown in FIG. 1, or at may be provided separately of the elevator control 15.

In an alternative configuration not shown in the figures, a separate door control device 22 may be provided at every landing. Each of said door control devices 22 may be configured for controlling the movement of the landing door 10 at the respective landing 8. It further may be configured for controlling the elevator car door 11 of the elevator car 6 when the elevator car 6 is positioned at the respective landing 8.

In the following, the term “doors 10, 11” encompasses the elevator car door 11, the landing doors 10 and any combination thereof.

Door drives 20 are provided at the doors 10, 11 and configured for moving the doors 10, 11.

The at least one door control device 22 is connected by electrical lines, which are not shown in FIG. 1, or by a wireless data connection with at least one associated passenger sensor 21 and with at least one corresponding door drive 20. The at least one door control device 22 in particular may be connected with the at least one associated passenger sensor 21 and with the at least one corresponding door drive 20 by an electric bus, e.g. a field bus such as a CAN-bus.

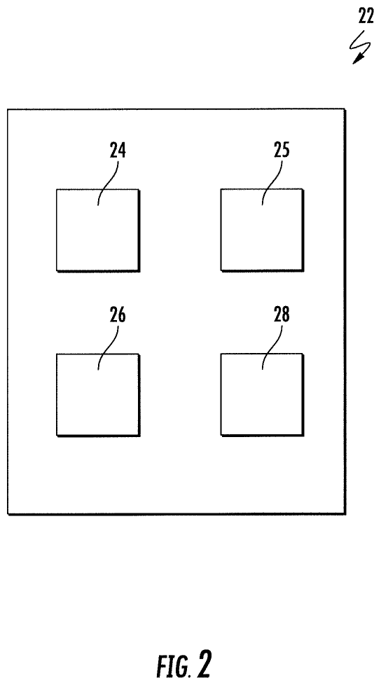

A schematic view of a door control device 22 according to an exemplary embodiment is depicted in FIG. 2.

The door control device 22 comprises a memory 24, in which at least one predefined movement profile is stored, and a selector 25 configured for selecting one of the predefined movement profiles.

The door control device 22 further comprises a modificator 28 configured for modifying the at least one predefined movement profile when at least one passenger sensor 21 detects a passenger 30 in the vicinity of at least one of the doors 10, 11, and a door controller 26 configured for controlling the movement of the at least one door 10, 11 according to the selected movement profile which has been modified or not.

The selector 25, the door controller 26 and the modificator 28 may be implemented in hardware as an electronic circuit, respectively. The selector 25, the door controller 26 and the modificator 28 in particular may include an application-specific integrated circuit (ASIC) customized for the respective tasks. Additionally or alternatively, the selector 25, the door controller 26 and the modificator 28 may include a programmable (micro-)processor, which is controlled by an appropriate program for executing the desired tasks.

At least two of the selector 25, the door controller 26 and the modificator 28 may be integrated into a single unit. Alternatively, the selector 25, the door controller 26 and the modificator 28 may be separate units of the door control device 22.

Modifying the at least one predefined movement profile may include multiplying the moving velocity of at least one door 10, 11 given by the at least one predefined movement profile with a numerical adjustment factor. A negative adjustment factor results in a reversal of the moving direction of the at least one door 10, 11. When the absolute value of the adjustment factor is below 1, the modification results in reducing the moving velocity of the at least one door 10, 11. When the absolute value of the adjustment factor is larger than 1, the modification results in increasing the moving velocity of the at least one door 10, 11.

The adjustment factor may be a constant factor. Alternatively, the adjustment factor may vary over time and/or it may depend on the position of the at least one door 10, 11 along its path. Using a flexible adjustment factor adds even more flexibility to the modification of the door movement allowing for a fine-grained tuning of the movement of the at least one door 10, 11.

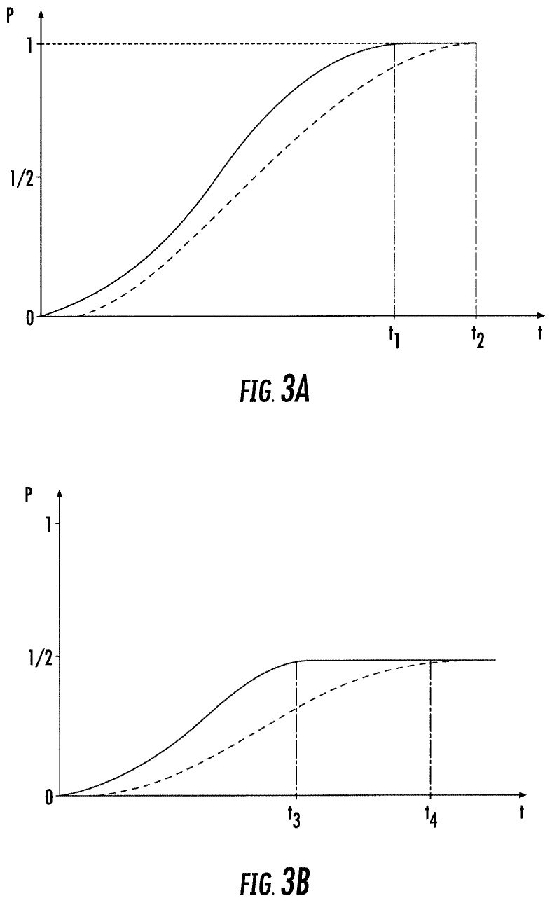

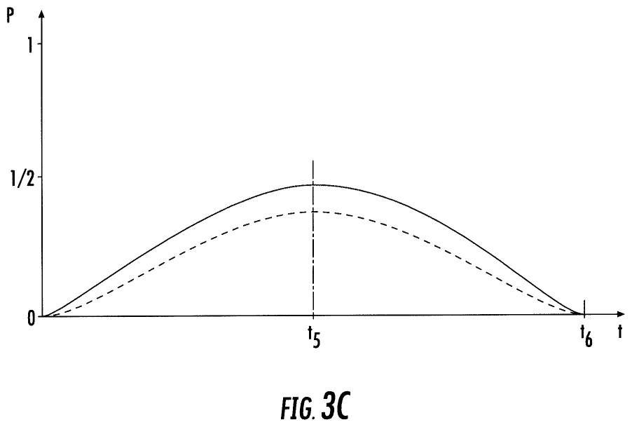

A plurality of exemplary movement profiles of doors 10, 11 are schematically illustrated in FIGS. 3A to 3C.

In FIGS. 3A to 3C the position p of one of the doors 10, 11 of the elevator system 2 is denoted on the vertical axis as a function of time t, which is denoted on the horizontal axis. A position p=0 represents a completely open door 10, 11, a position p=1 represents a completely closed door 10, 11, and a position p=½ represents a door 10, 11 which is closed halfway.

The solid line in FIG. 3A illustrates a predefined movement profile corresponding to a standard closing movement of the door 10, 11. The movement of the door 10, 11 starts at t=0, p=0 and the door 10, 11 is completely closed (p=1) at t=t₁.

The dashed line represents a corresponding modified movement profile in which the moving velocity of the door 10, 11 is reduced with respect to the standard profile (solid line). In consequence, the slope of the dashed curve corresponding to the velocity of the door 10, 11 is smaller and the door 10, 11 is closed (p=1) at a later time t=t₂>t₁.

The solid line in FIG. 3B illustrates a predefined movement profile corresponding to a closing movement of the door 10, 11, wherein the movement of the door 10, 11 is stopped halfway (p=½) at t=t₃.

Again, the dashed line represents a corresponding modified movement profile in which the moving velocity of the door 10, 11 is reduced with respect to the profile represented by the solid line. In consequence, the slope of the dashed curve corresponding to the velocity of the door 10, 11 is smaller and the door 10, 11 reaches its final position, in which is halfway open and halfway closed (p=½), at a later time t=t₄>t₃.

The solid line in FIG. 3C illustrates a predefined movement profile corresponding to a closing movement of the door 10, 11, wherein the movement of the door 10, 11 is reversed at t=t₅ (p=½). Thus, the door 10, 11 is completely open again at a time t₆>t₅.

The dashed line represents a corresponding modified movement profile in which the moving velocity of the door 10, 11 is reduced with respect to the profile represented by the solid line.

When the modified profile is used, the movement of the door 10, 11 is also reversed at t=t₅. Due to the reduced velocity, the door 10, 11, however, has not reached the halfway position (p=½) at t₅.

As in the example illustrated in FIG. 3C, in the modified case as well as in the unmodified case, the velocity of the closing movement (t<t₅) is identical with the velocity of the opening movement (t>t₅), the door 10, 11 is completely open again (p=0) at t₆ independently whether the modified or the unmodified velocity profile is used.

The skilled person will understand that the movement profiles illustrated in FIGS. 3A to 3C are only illustrative examples and that other movement profiles and alternative modifications of the movement profiles may be used.

For example the movement of the doors 10, 11 may be stopped or reversed at another position than the halfway position and/or the velocity with which the doors 10, 11 are closed may differ from the velocity with which the door 10, 11 are opened.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention is not limited to the particular embodiments disclosed, but that the invention includes all embodiments falling within the scope of the claims.

### REFERENCES

2 elevator system

3 tension member

4 hoistway

4a upper end of the hoistway

4b bottom of the hoistway

5 drive

6 elevator car

7a elevator hall call button

7b elevator cat control button

8 landing

10 landing door

11 elevator car door

15 elevator control

16 floor of the elevator car

17 sidewall of the elevator car

18 ceiling of the elevator car

19 position sensor

20 door drive

21 passenger sensor

22 door control device

24 memory

25 selector

26 door controller

28 modificator

30 passenger

What is claimed is:

1. Elevator system (2) comprising:
at least one elevator car (6) moving within a hoistway (4);
at least one door (10, 11) providing access to the elevator car (6);
at least one passenger sensor (21) configured for detecting passengers (30) in the vicinity of the at least one door (10, 11); and
a door control device (22) configured for controlling the at least one door (10, 11),
wherein the door control device (22) comprises:
a memory (24) in which at least one predefined movement profile is stored;
a modificator (28) configured for modifying the at least one predefined movement profile when the at least one passenger sensor (21) detects a passenger (30) in the vicinity of the at least one door (10, 11); and
a door controller (26) configured for controlling the movement of the at least one door (10, 11) based on the at least one movement profile.

2. Elevator system (2) according to claim 1, wherein modifying the at least one predefined movement profile includes reducing the moving velocity of the at least one door (10, 11).

3. Elevator system (2) according to claim 1, wherein modifying the at least one predefined movement profile includes reversing the moving direction of the at least one door (10, 11).

4. Elevator system (2) according to claim 1, wherein modifying the at least one predefined movement profile includes multiplying a moving velocity of the elevator car (6) given by the at least one predefined movement profile with an adjustment factor.

5. Elevator system (2) according to claim 4, wherein the adjustment factor is constant.

6. Elevator system (2) according to claim 4, wherein the adjustment factor is variable, in particular variable over time.

7. Elevator system (2) according to claim 1, wherein the at least one passenger sensor (21) is configured for detecting the number of passengers (30) in the vicinity of the at least one door (10, 11), and wherein the adjustment performed by the modificator (28) depends on the number of passengers (30) detected in the vicinity of the at least one door (10, 11).

8. Elevator system (2) according to claim 1, wherein the at least one passenger sensor (21) is configured for detecting the distance of at least one passenger (30) from the at least one door (10, 11), and wherein the adjustment performed by the modificator (28) depends on the detected distance of the at least one passenger (30) from the at least one door (10, 11).

9. Elevator system (2) according to claim 1, wherein the at least one passenger sensor (21) is configured for detecting the moving speed of at least one passenger (30) in the vicinity of the at least one door (10, 11), and wherein the adjustment performed by the modificator (28) depends on the detected moving speed of the at least one passenger (30) in the vicinity of the at least one door (10, 11).

10. Elevator system (2) according to claim 1, wherein the door control device (22) further comprises a selector (25) configured for selecting one of the at least one predefined movement profiles store within the memory (24).

11. Elevator system (2) according to claim 1, wherein the at least one door (10, 11) is a landing door (10) or an elevator car door (11) of the elevator system (2).

12. Method of controlling the movement of at least one door (10, 11) of an elevator system (2), the at least one door (10, 11) providing access to an elevator car (6) of the elevator system (2), wherein the method includes:
retrieving a predefined movement profile for the at least one door (10, 11) from a memory (24);
detecting the presence of at least one passenger (30) in the vicinity of the at least one door (10, 11);
modifying the retrieved predefined movement profile when the presence of at least one passenger (30) in the vicinity of the at least one door (10, 11) has been detected;
controlling the movement of the at least one door (10, 11) according to the modified movement profile.

13. Method according to claim 12, wherein modifying the at least one predefined movement profile includes reducing the moving velocity of the at least one door (10, 11), and/or reversing the moving direction of the at least one door (10, 11).

14. Method according to claim 12, wherein modifying the at least one predefined movement profile includes multiplying a moving velocity of the at least one door (10, 11) given by the at least one predefined movement profile with a predetermined adjustment factor.

15. Method according to claim 12,
wherein the method includes detecting at least one of
a number of passengers (30) in the vicinity of the at least one door (10, 11);
a distance of at least one passenger (30) from the at least one door (10, 11); and
a moving speed of at least one passenger (30) in the vicinity of the at least one door (10, 11); and
wherein modifying the predefined movement profile depends on at least one of
the number of passengers (30) detected in the vicinity of the at least one door (10, 11);
the detected distance of the at least one passenger (30) from the at least one door (10, 11); and
the detected moving speed of the at least one passenger (30) in the vicinity of the at least one door (10, 11).
